(19) United States
(12) Patent Application Publication
(10) Pub. No.: US 2025/0291634 A1
(43) Pub. Date: Sep. 18, 2025

(54) Ubiquitous Computing Characteristics Profile

(71) Applicant: Apple Inc., Cupertino, CA (US)

(72) Inventors: Walter FEATHERSTONE, Cirencester (GB); Mona AGNEL, Guildford (GB); Ralf ROSSBACH, Munich (DE); Sudeep MANITHARA VAMANAN, Uttenreuth (DE)

(21) Appl. No.: 18/607,741

(22) Filed: Mar. 18, 2024

(51) Int. Cl. G06F 9/50

(52) U.S. Cl. CPC G06F 9/5027

(57) ABSTRACT

An apparatus configured to generate, for transmission to a network, a request for computing resource availability for a computing task to be offloaded from the apparatus, wherein the request comprises an indication of a Ubiquitous Computing Characteristics Profile (UCCP) comprising one or more attributes related to the computing task and process, based on signals received from the network, computing node information associated with a network node, wherein the apparatus offloads the computing task to the network node.

### BACKGROUND

It has been identified that certain types of applications and services may experience performance benefits from more agile computing and communication mechanisms. For example, cellular networks (e.g., 6G networks) may provide additional services beyond communications. For example, 6G networks may provide a ‘compute as a service’ platform where carriers may utilize data centers to provide computing resources to enterprise (or other) customers.

Ubiquitous computing (sometimes also referred to as distributed computing) is a technology area that may enable any application or workload that resides on any device to be executed on any nearby or remote computing resource. Available computing resources may be user devices (e.g., smartphone, computer), network operator computing resources (e.g., servers located in operator data centers or co-located with network nodes) and third party computing resources (e.g., cloud resources owned by third parties).

To achieve this goal, the 6G network may act as a computing platform that matches applications (or workloads) on any device or Third Generation Partnership (3GPP) network function or service needing computing resources with available computing resources, and enables the workload to be transferred, executed and the results returned to the triggering application.

### SUMMARY

Some example embodiments are related to an apparatus having processing circuitry configured to generate, for transmission to a network, a request for computing resource availability for a computing task to be offloaded from the apparatus, wherein the request comprises an indication of a Ubiquitous Computing Characteristics Profile (UCCP) comprising one or more attributes related to the computing task and process, based on signals received from the network, computing node information associated with a network node, wherein the apparatus offloads the computing task to the network node.

Other example embodiments are related to an apparatus having processing circuitry configured to generate, for transmission to a network, computing resource availability information comprising an indication of a Ubiquitous Computing Characteristics Profile (UCCP) comprising one or more attributes and establish a user plane with a user equipment (UE), wherein the UE offloads a computing task to the apparatus based on the UCCP.

Still further example embodiments are related to one or more processors of a distributed computing management function (DCMF) configured to process, based on signals received from a first network node, computing resource availability information comprising an indication of a first Ubiquitous Computing Characteristics Profile (UCCP) comprising one or more attributes, process, based on signals received from a second network node a request for computing resource availability for a computing task to be offloaded from the apparatus, wherein the request comprises an indication of a second UCCP comprising one or more attributes related to the computing task and determine whether the first UCCP satisfies the one or more attributes of the second UCCP.

### BRIEF DESCRIPTION OF THE DRAWINGS

FIG. 1 shows an example network arrangement according to various example embodiments.

FIG. 2 shows an example network arrangement according to various example embodiments.

FIG. 3 shows an example network architecture according to various example embodiments.

FIG. 4 shows an example user equipment (UE) according to various example embodiments.

FIG. 5 shows an example base station according to various example embodiments.

FIG. 6 shows an example Ubiquitous Computing Characteristics Profile (UCCP) table according to various example embodiments.

FIG. 7 shows an example signaling diagram for centralized node matching according to various example embodiments.

FIG. 8 shows a layer model for abstracting the UCCP profile matching according to various example embodiments

### DETAILED DESCRIPTION

The example embodiments may be further understood with reference to the following description and the related appended drawings, wherein like elements are provided with the same reference numerals. The example embodiments are related to a Ubiquitous Computing Characteristics Profile (UCCP) that may be used to match a requestor node (e.g., a device that is attempting to offload a computing task) to a computing node (e.g., a device or node that is able to perform the computing task). As will be described in more detail below, the UCCP allows nodes (e.g., requestor nodes or computing nodes) to expose a minimum amount of information that may be used for matching but may keep the nodes identity and/or operations (e.g., the current application being executed) private.

The example embodiments are described with regard to a user equipment (UE). However, reference to a UE is provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a 6G network that integrates communication and computing resources into the same network fabric. This approach may enable ubiquitous computing functionality for the applications and services being used by the devices deployed within the network. For example, in contrast to a network architecture that primarily utilizes edge computing services, the example embodiments may utilize computing resources from locations that span from on-device to the network edge and the computing nodes in between. However, reference to a 6G network is merely provided for illustrative purposes. The example embodiments may be implemented by a 6G network, a 5G network, a 5G-Advanced network or any other appropriate type of network that implements the type of functionalities described herein for ubiquitous computing.

Throughout this description the term “network node” should be understood to mean any device/function that is part of the network, e.g., RAN or core network, or any device that connects to the network (directly or indirectly), e.g., UE, components of an edge date network, servers (operator or third parties), etc.

Throughout this description, the term “requestor node” may refer to any device/entity that has a computing need. For example, a requestor node may include a UE that is executing a particular application and would like to offload a computing task associated with the application (e.g., rendering, etc.).

The following provides an example use case of a requestor node. This is only an example of a single use case and some additional examples of other use cases are also provided further below. The example embodiments are not limited to any particular use case and as will be described in further detail below, while a UCCP may be defined for a particular use case, even that UCCP may not be limited to use with the use case for which it was defined.

The example use case may be related to a scenario where the UE is an augmented reality (AR)/virtual reality (VR) device such as a wearable headset. AR/VR devices may use stereoscopic technology where a pair of two-dimensional images are presented to the use, e.g., left image to the left eye and right image to the right eye. The human brain perceives the image as a single three-dimensional (3D) view giving the user the perception of 3D depth. However, the 3D effect may lack proper focal depth and may contain a single depth-plane that gives rise to a phenomena termed the Vergence-Accommodation Conflict. This occurs when the brain receives mismatching cues between vergence and accommodation of the eye, which may be unpleasant and cause eye strain. To overcome this issue, digital holography may be used to provide depth information to the rendered display. However, generating digital holographic images is a processor and power intensive computing task. The UE may desire to offload this computing task to another computing node. Thus, in this example, the AR/VR device may be termed a requestor node.

Throughout this description, the term “computing node” may refer to any device/entity with computing resources. In some examples, the computing node may be part of a network communication node (e.g., relay node, radio access network (RAN) node) or a node hosted in an edge data network (RAN or third party). In other examples, a computing node may be part of the UE (or other UE) and further characterized as a “UE based computing node.” A UE may also be characterized as a node with a computing need and there may be deployment scenarios where a single UE acts as a node with computing resources and a node with a computing need for one or more services. In further examples, a computing node may be a third party node that is not part of the RAN such as a cloud computing service.

Throughout this description, the term “matching node” may refer to any device/entity that matches a requestor node with a computing node. For example, a requestor node may request a computing service based on a UCCP and a matching node may match the requestor node with a computing node that supports the UCCP. The matching node may be any node within the network including, but not limited to, the requestor node, the computing node, a network communication node (e.g., relay node, radio access network (RAN) node, core network node or function), etc. The matching process performed by the matching node will be described in greater detail below.

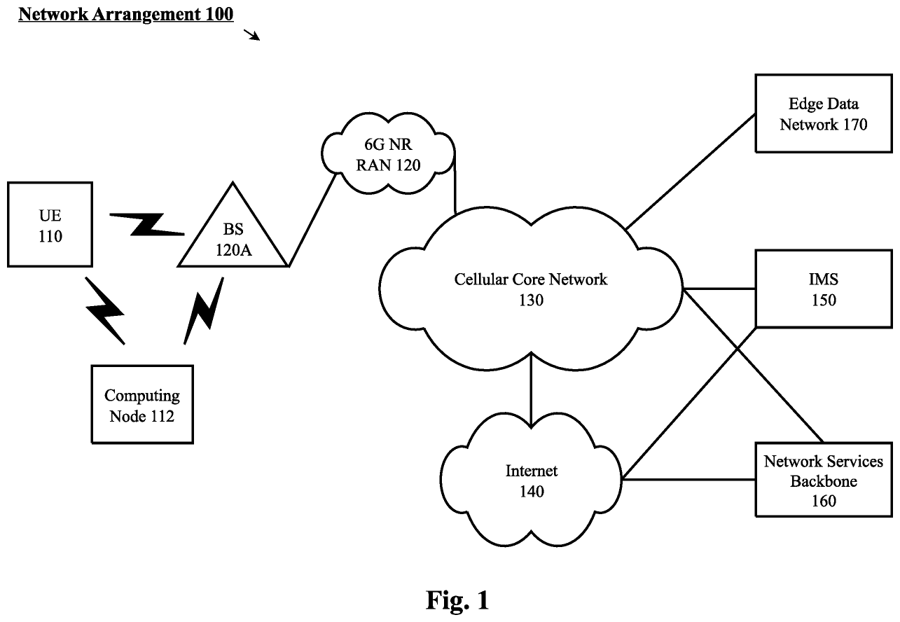

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, a smart speaker, head mounted display (HMD), augmented reality (AR)/virtual reality (VR) glasses, etc. An actual network arrangement may include any number of UEs being used by any number of users. Thus, the example of a single UE 110 is merely provided for illustrative purposes.

The example arrangement 100 also includes a computing node 112. In some examples, the computing node 112 may be a UE which is described above as any type of electronic component that is configured to communicate via a network, e.g., mobile phones, tablet computers, desktop computers, smartphones, phablets, embedded devices, wearables, Internet of Things (IoT) devices, smart speakers, multimedia devices, head mounted displays (HMDs), augmented reality (AR) glasses, etc. In the description of the example arrangement 100, the UE 110 is characterized as a device that may have a computing need. However, as mentioned above, the UE 110 may also serve as a computing node for itself and/or other devices.

To provide a general example, the UE 110 may have a computing need (e.g., the UE 110 is a requestor node) and the computing node 112 may be configured to serve the computing need of the UE 110. The computing node 112 may provide computing services for the UE 110 without the data traversing the core network 130 or any other network nodes (e.g., base station 120A, the RAN 120, etc.). However, the example provided above is merely for illustrative purposes and is not intended to limit the example embodiments in any way. Specific examples regarding registering as a computing node in the network, determining resource availability at computing nodes, requesting computing resources and matching a request for resources with one or more computing node are provided in detail below.

In other examples, the computing node 112 may be part of an intermediate node. The intermediate node may as any type of electronic component that is configured to communicate with other network devices, e.g., a relay, an integrated access backhaul (IAB), a home server, a third-party deployed node, a drone, a component of a non-terrestrial network, etc. In this example, the computing node 112 may also provide computing services for the UE 110 without the data traversing the core network 130 or any other network nodes (e.g., base station 120A, the RAN 120, etc.). The example provided above is merely for illustrative purposes and is not intended to limit the example embodiments in any way. Specific examples regarding registering as a computing node in the network, determining resource availability at computing nodes, requesting computing resources and matching a request for resources with one or more computing node are provided in detail below.

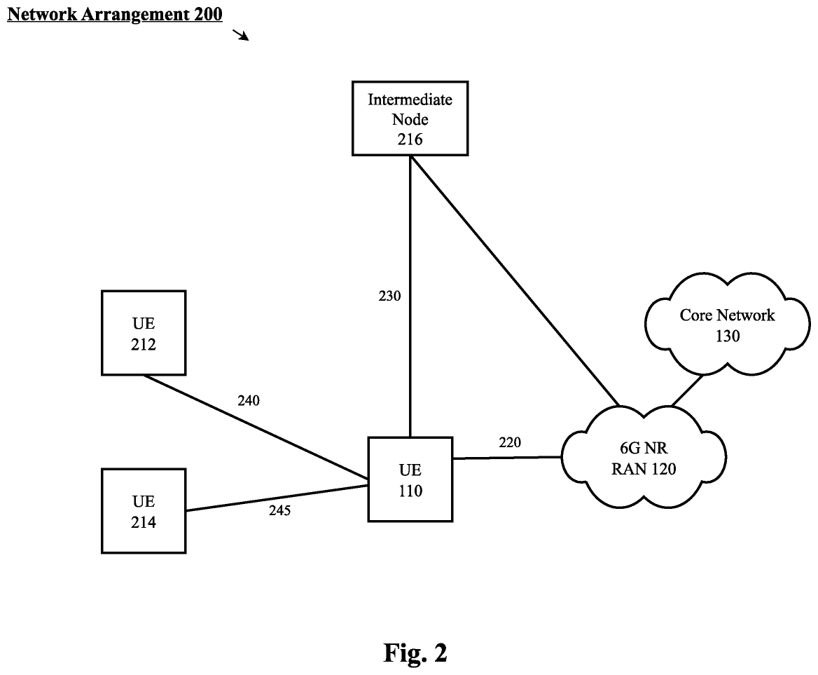

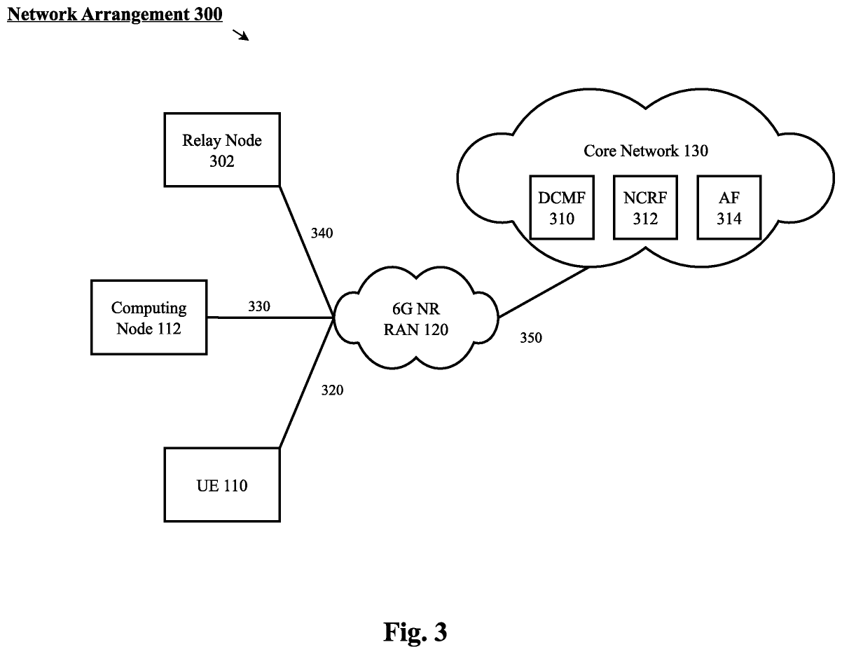

In further examples, the computing nodes may also be part of the RAN 120, the core network 130 or hosted in the edge data network 170. Thus, reference to a single computing node 112 is merely provided for illustrative purposes, an actual network arrangement may include any number of computing nodes deployed at any appropriate virtual and/or physical location (e.g., within the mobile network operator's domain or within a third-party domain). Additional examples regarding the interactions and relationships between devices with computing needs (e.g., UE 110) and computing nodes are shown below in FIGS. 2-3.

The UE 110 may be configured to communicate with one or more networks. In the example of the network arrangement 100, the network with which the UE 110 may wirelessly communicate is a 6G radio access network (RAN) 120. However, the UE 110 may also communicate with other types of networks (e.g., 5G cloud RAN, a next generation RAN (NG-RAN), a long term evolution (LTE) RAN, a legacy cellular network, a wireless local area network (WLAN), etc.) and the UE 110 may also communicate with networks over a wired connection. With regard to the example embodiments, the UE 110 may establish a connection with the 6G RAN 120. Therefore, the UE 110 may have a 6G chipset to communicate with the 6G RAN 120.

The 6G RAN 120 may be a portion of a cellular network that may be deployed by a network carrier. The 6G RAN 120 may include, for example, cells or base stations (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 5G NR RAN 120. More specifically, the UE 110 may associate with a specific base station (e.g., base station 120A).

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC) and/or 6G core. The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

In addition, the network arrangement 100 includes an edge data network 170. The edge data network provides support required for various different types of network entities, e.g., edge applications server (EAS), edge enabler server (EES), etc. An actual network arrangement may include any appropriate number of edge data networks. Thus, the example of a single edge data network 170 is merely provided for illustrative purposes.

FIG. 2 shows an example network arrangement 200 according to various example embodiments. The example network arrangement 200 includes the UEs 110, 212, 214, intermediate node 216, the 6G RAN 120 and the core network 130. In this example, the UE 110 is a device with a computing need while the other devices (e.g., UEs 212-214, intermediate node 216) and nodes of the RAN 120 or the core network 130 may serve as computing nodes for the requestor node UE 110. Although not shown in the network arrangement 200, a node deployed within an edge data network may also serve as a computing node for the requestor node UE 110.

Thus, in the example of FIG. 2, the requestor node UE 110 has a computing need and the UEs 212-214, intermediate node 216, nodes of the RAN 120, and/or node of the core network 130, and/or node of the edge data network 170 may have computing services that may satisfy the computing need of the requestor node UE 110. However, there exists a need to match the computing need of the UE 110 with any available computing services (e.g., available computing nodes). A challenge is ensuring privacy of requestor nodes (e.g., the UE 110) or computing nodes (e.g., UEs 212-214, intermediate node 216, nodes of the RAN 120, and/or node of the core network 130) in the distributed computing framework, while acknowledging that such nodes are able to communicate their requirements, constraints and capabilities to enable matching to be performed appropriately, e.g., matching a requestor node to one or more computing node(s).

Therefore, from a privacy perspective, when sharing computing offload requirements, it may be desirable to only share a minimum number of attributes that are necessary to perform successful node matching. A requestor node may be willing to expose additional attributes in the request to obtain a more specific match to fulfil the requestor node computing needs, but inclusion of such optional attributes is not required.

It is also desirable to enable the exchange of information to be performed in a simple manner, without revealing the exact nature of the task/application/function being offloaded by the requestor node, or advertising too much detail about the capabilities of the computing node.

In some example embodiments, computing characteristics may be expressed in a Ubiquitous Computing Characteristics Profile (UCCP). The term UCCP is used below to refer to a manner of expressing computing characteristics that may show the computing need of the requestor node or the computing capabilities of the computing node(s). However, the name UCCP is only an example, other entities may refer to the same concept using different names.

A computing request may be served by the network (e.g., 6G network) by being associated with a UCCP. The UCCP may be used to characterize an application, or a standard function (e.g., math lib, a special type of video processing, etc.). In some example embodiments, the UCCP may be mapped to a Quality of Service (QOS) profile. For example, the special type of video processing may have an associated QoS profile. The UCCP for the special type of video processing may then be associated with the Qos profile. Thus, the associated QoS profile and UCCP may define the transport requirements and the processing requirements, respectively, for the special type of video processing.

There is no requirement that a UCCP be associated with a QoS profile. The association is just one example of how a UCCP may be used. The UCCP may also be used independently of any QoS profile for a service or application.

The network may define a rule as to how to map a computing request having certain computing characteristics (e.g., as expressed by a UCCP) with a communication Qos (e.g., as expressed by a QoS profile) such as a flow or a signaling/data bearer to transfer computing related information. The mapping rule may be predefined in a standard (e.g., 3GPP Technical Specifications), controlled by a controlling network function (NF), which is configurable or controlled by the network operator or generated by artificial intelligence (AI)/machine learning (ML).

FIG. 3 shows an example network architecture 300 according to various example embodiments. The following description will provide a general overview of the various components of the example architecture 300. The specific operations performed by the components with respect to the example embodiments will be described in greater detail after the description of the architecture 300.

The example architecture 300 shows an example of the types of entities that may be used to implement an example distributed intelligent layer that is able to perform tasks such as, but not limited to, collecting and analyzing information on communication and computing resources in a mobile wireless network, discovering available resources, determining a path between a device with a computing need and a device with computing resources and assisting in executing computing offload. As mentioned above with regard to the example network arrangements 100-200 and as will be shown in more detail below, by integrating computing and communication resources in the same network fabric, the mobile network may utilize network operator provisioned, third party provisioned and/or user provisioned computing resources for a requestor node deployed within the network (e.g., the UE 110).

The components of the example architecture 300 may reside in various physical and/or virtual locations relative to the network arrangement 100 of FIG. 1. These locations may include, within the access network (e.g., RAN 120), within the core network 130, as separate components outside of the locations described with respect to FIG. 1, etc.

In FIG. 3, the various components are shown as being connected via interfaces 320-350. These interfaces are not required to be direct wired or wireless connections, e.g., the interfaces may communicate via intervening hardware and/or software components. To provide an example, the UE 110 may exchange signals over the air with the base station 120A. However, in the architecture 300 the UE 110 is shown as having a connection to the RAN 120. This interface is not a direct communication link between the UE 110 and the RAN 120, instead, it is a connection that is facilitated by intervening hardware and software components. In another example, the interfaces may be implemented as a service based interface or an application program interface (API). Thus, throughout this description the terms “connection” and “interface” may be used interchangeably to describe the interfaces between the various components.

The architecture 300 includes the UE 110, the RAN 120, the computing node 112, a relay node 302 and the core network 130. The core network 130 includes a distributed computing management function (DCMF) 310, a network compute repository function (NCRF) 312 and an application function 314. Although not shown in the example architecture 300, the core network 130 may also include other functions such as, but not limited to, a session management function (SMF), a registration function, an authentication function, a policy management function, a RAN management function, an analytics function, a network exposure function, a user plane function and a control plane function. However, any reference to the core network 130 including a particular type of function is merely provided for illustrative purposes.

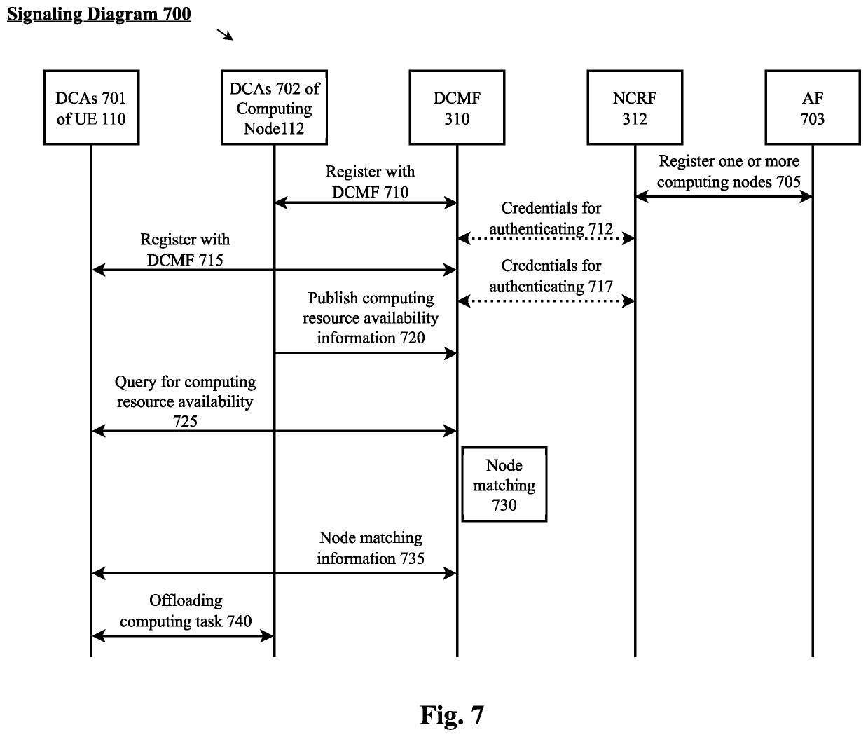

The DCMF 310 is generally responsible for onboarding, provisioning network nodes with computing resources and network nodes with computing needs. In addition, the DCMF 310 may also be responsible for discovery of adequate computing resources and communication paths. The DCMF 310 may also be configured to consider trust and privacy requirements from application providers and users when performing its operations. The example embodiments are not limited to a DCMF that performs the above referenced operations. Specific examples of operations that may be performed by the DCMF are provided in detail below with regard to FIG. 7. However, reference to the term DCMF is merely provided for illustrative purposes, different entities may refer to similar concepts by a different name. Further, reference to a single DCMF 310 is merely for illustrative purposes, an actual network arrangement may include any appropriate number of DCMFs.

The NCRF 312 is generally responsible for registering network nodes with computing resources, aiding their onboarding and discovery. The NCRF 312 may include various enhancements to the 5G network repository function (NRF). The example embodiments are not limited to a NCRF that performs the above referenced operations. Specific examples of operations that may be performed by the NCRF 312 are provided in detail below with regard to FIG. 7. However, reference to the term NCRF is merely provided for illustrative purposes, different entities may refer to similar concepts by a different name. Further, reference to a single NCRF 312 is merely for illustrative purposes, an actual network arrangement may include any appropriate number of NCRFs.

The example embodiments are also described with regard to distributed computing agent (DCA) which generally refers to entity that is embedded in network nodes that provides and/or requests computing resources. In some embodiments, the DCA may act as an application client (DCAc) and perform operations such as, but not limited to, requesting computing resources, receiving a response to the request indicating a computing node assigned to the DCAc or receiving a response to the request comprising information about candidate computing nodes. In other embodiments, the DCA may act as an application server (DCAs) and perform operations such as, but not limited to, publishing information about resource availability in the computing nodes and handling request for computing resources. A single entity may have both DCAc and DCAs active at the same time for different services. Although the DCAc is referred to as an application client, from the perspective of the DCMF, the DCA (e.g., DCAc or DCAs) is a client entity.

Within the context of the network architecture 300, any of the network nodes may operate as a DCAc and/or DCAs. To provide a general example, consider one possible scenario in which the UE 110 is a requestor node that has a computing need and thus, a DCA entity of the UE 110 may operate as a DCAc. In this example, the computing node 112 may be another UE (e.g., desktop, laptop, home server, etc.) with available computing resources. Thus, the DCA of the computing node 112 may operate as a DCAs for the DCAc of the UE 110. Similarly, the relay node 302 and the network nodes of the RAN 120 may also have available computing resources. Thus, the DCA of the relay node 302 and the network nodes of the RAN 120 may operate as a DCAs for the DCAc of the UE 110. In addition, although not shown in the network architecture 300, a node hosted in an edge data network may also have available computing resources and operate as a DCAs for the DCAc of the UE 110. However, the above examples are merely provided for illustrative purposes and not intended to limit the example embodiments in any way. The above example provides a general overview of possible interactions between the DCA of the UE 110 and the DCA of the other candidate computing nodes of the UE 110 within the example network architecture 300 depicted in FIG. 3. There are a significant number of different possible arrangements of network nodes and scenarios in which the ubiquitous computing functionality described herein may be utilized.

The example network architecture 300 may employ various techniques to ensure the privacy of the clients and the computing nodes processing their data. To provide some examples, the DCMF 310 may be configured such that it may not be aware of what the actual computing task to be performed comprises. Instead, the DCMF 310, the DCAs and the DCAc may handle computing tasks identified by a UCCP. In another example, the communication path between the requestor node and the computing node may be managed by the mobile network. Thus, the device with the computing need may be unaware of where the computing node is situated. In addition, a trust level may control which computing nodes may be matched to a device with a computing need. However, the example embodiments do not require nor are they limited to these privacy techniques. The example embodiments may utilize any appropriate type of techniques to ensure the privacy of the clients and the computing nodes processing their data.

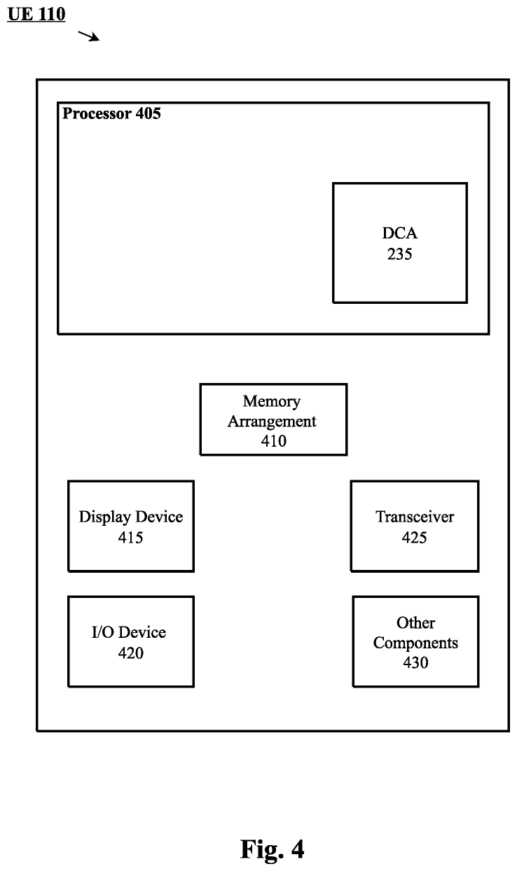

FIG. 4 shows an example UE 110 according to various example embodiments. The UE 110 will be described with regard to the network arrangement 100 of FIG. 1 and the network architecture 300 of FIG. 3. The UE 110 may operate as a requestor node, a computing node or both. The UE 110 may include a processor 405, a memory arrangement 410, a display device 415, an input/output (I/O) device 420, a transceiver 425 and other components 430. The other components 430 may include, for example, an audio input device, an audio output device, a power supply, a data acquisition device, ports to electrically connect the UE 110 to other electronic devices, etc.

The processor 405 may be configured to execute various types of software. For example, the processor may execute a DCA 435. The DCA 435 may perform operations related to requesting and/or receiving computing resources. In some examples, the DCA 435 may operate as a DCAc and perform operations related to accessing computing resources. In other examples, the DCA 435 may operate as a DCAs and perform operations related to operating as a computing node for other network nodes. The UE 110 may have both DCAc and DCAs active at the same time for different services.

The above referenced software being executed by the processor 405 is only example. The functionality associated with the software may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The software may also be embodied as one application or separate applications. In addition, in some UEs, the functionality described for the processor 405 is split among two or more processors such as a baseband processor and an applications processor. The example embodiments may be implemented in any of these or other configurations of a UE.

The memory arrangement 410 may be a hardware component configured to store data related to operations performed by the UE 110. The display device 415 may be a hardware component configured to show data to a user while the I/O device 420 may be a hardware component that enables the user to enter inputs. The display device 415 and the I/O device 420 may be separate components or integrated together such as a touchscreen.

The transceiver 425 may be a hardware component configured to establish a connection with the 5G NR-RAN 120 and/or any other appropriate type of network. Accordingly, the transceiver 425 may operate on a variety of different frequencies or channels (e.g., set of consecutive frequencies). The transceiver 425 includes circuitry configured to transmit and/or receive signals (e.g., control signals, data signals). Such signals may be encoded with information implementing any one of the methods described herein. The processor 405 may be operably coupled to the transceiver 425 and configured to receive from and/or transmit signals to the transceiver 425. The processor 405 may be configured to encode and/or decode signals (e.g., signaling from a base station of a network) for implementing any one of the methods described herein.

While the above description of the UE 110 described a wireless capable device as operating as the requestor node and/or computing node, a wired device that is capable of communicating with the network may also operate as a requestor node and/or computing node. In such a case, the device may have a network interface to communicate with the network but otherwise may operate in a similar manner as described for UE 110 when performing operations related to a requestor node and/or computing node.

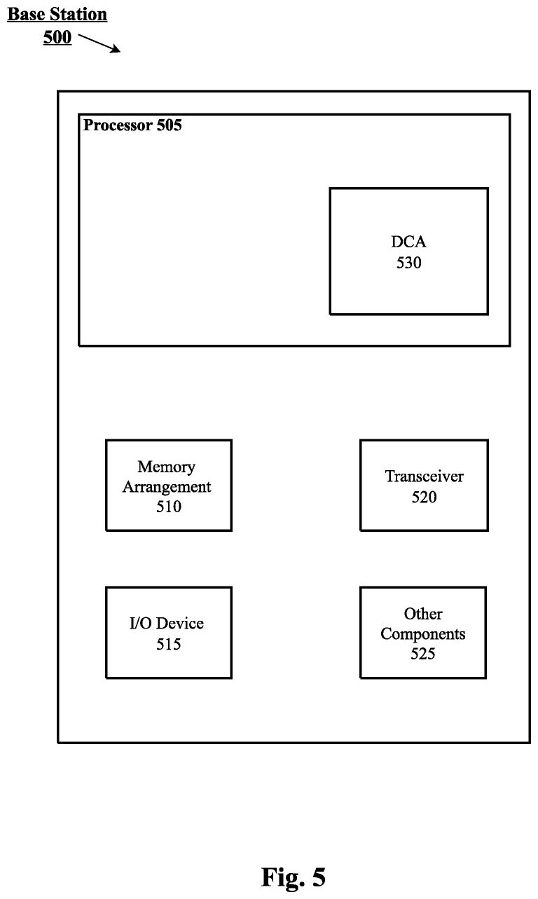

FIG. 5 shows an example base station 500 according to various example embodiments. The base station 500 may represent the base station 120A, the intermediate node 216, the relay node 302 or any other access node through which the UE 110 may establish a connection and manage network operations.

The base station 500 may include a processor 505, a memory arrangement 510, an input/output (I/O) device 515, a transceiver 520, and other components 525. The other components 525 may include, for example, an audio input device, an audio output device, a battery, a data acquisition device, ports to electrically connect the base station 500 to other electronic devices, etc.

The processor 505 may be configured to execute a plurality of engines for the base station 500. For example, the engines may include a DCA 530. The DCA 530 may perform various operations related to requesting and/or receiving computing resources.

The above references software (e.g., DCA 530) being executed by the processor 505 is only example. The functionality associated with the engine 530 may also be represented as a separate incorporated component of the base station 500 or may be a modular component coupled to the base station 500, e.g., an integrated circuit with or without firmware. For example, the integrated circuit may include input circuitry to receive signals and processing circuitry to process the signals and other information. In addition, in some base stations, the functionality described for the processor 505 is split among a plurality of processors (e.g., a baseband processor, an applications processor, etc.). The example embodiments may be implemented in any of these or other configurations of a base station.

The memory arrangement 510 may be a hardware component configured to store data related to operations performed by the base station 500. The I/O device 515 may be a hardware component or ports that enable a user to interact with the base station 500. The transceiver 520 may be a hardware component configured to exchange data with the UE 110 and any other network node within the network arrangement 100, the network architecture 300 or nodes outside of the locations described with respect to FIGS. 1 and 3.

The transceiver 520 may operate on a variety of different frequencies or channels (e.g., set of consecutive frequencies). Therefore, the transceiver 520 may include one or more components (e.g., radios) to enable the data exchange with the various networks and UEs. The transceiver 520 includes circuitry configured to transmit and/or receive signals (e.g., control signals, data signals). Such signals may be encoded with information implementing any one of the methods described herein. The processor 505 may be operably coupled to the transceiver 520 and configured to receive from and/or transmit signals to the transceiver 520. The processor 505 may be configured to encode and/or decode signals (e.g., signaling from a UE) for implementing any one of the methods described herein.

The example network arrangements 100-200 of FIGS. 1-2 and the example network architecture 300 of FIG. 3 described above included examples of the type of entities that may be utilized to enable the integration of computing and communication resources. The example embodiments described below introduce various techniques that may be utilized by those example entities to enable the network to implement the ubiquitous computing functionality described herein.

According to some aspects, the example embodiments introduce techniques to map specific computing needs of a requestor node to a generic UCCP that masks the specifics of the application being executed from the matching process and also enables straightforward matching to computing nodes that may indicate their own supported UCCP(s).

To start with a counter example, if a requestor node were to advertise its computing needs including multiple computing attributes, a matching node may have trouble matching all of the multiple computing attributes to a computing node, e.g., computing nodes may satisfy some of the multiple computing attributes but no computing nodes satisfy all of the multiple computing attributes. This may result in a matching node being unable to match the requestor node with a computing node.

When the requestor node maps its computing needs to a generic UCCP, the matching node may not need to match every single computing attribute to find a suitable computing node. Rather, the matching node may find a computing node that supports the generic UCCP profile for matching.

In some example embodiments, each UCCP may be associated with a Ubiquitous Compute Characteristics Indicator (UCCI) index, meaning that it may be sufficient to signal only the UCCI and not the full UCCP. Thus, a requestor node, when sending a request for offloading a computing take may simply include a value for the UCCI index and the matching node may determine which computing nodes support the UCCI index. The requestor node may not have to provide any additional information beyond the value of the UCCI index.

In some example embodiments, the requestor node may be able to select the UCCP irrespective of the service/application the requestor node is utilizing, e.g., UCCPs may not be tied to specific applications. For example, if a UCCP has been created based on a split rendering use case (e.g., where some portions of a rendering are performed locally and other portions of the rendering are distributed), the requestor node is not limited to using that UCCP solely for split rendering applications. The DCA of the requestor node may make this selection based on the service/application being executed, the computing task to be offloaded, etc. In some examples, a user of the requestor node may make a UCCP selection.

In some example embodiments, different profiles may have a different set of mandatory and optional attributes. Optional attributes may be considered as guidance for matching, whereas mandatory attributes must be fulfilled. In some examples, the requestor node may only signal the mandatory attributes for the UCCP, e.g., optional attributes may not be signaled as part of the request. In other examples, both the mandatory and optional attributes may be signaled as part of the request. In some example embodiments, a particular UCCP may have multiple attributes and a requestor node may select, for example, which of the multipole attributes are mandatory, which are optional and which may be ignored.

Each attribute may have an associated range or tolerance. For example, task size (code) may be represented differently on a computing node as compared to the requestor node. Attributes of the UCCP may have a dependency on one another and may also be derived from one another. For example, to achieve a certain delivery time a certain computing power may be required for a given task size. However, communication bandwidth between the requestor node and computing node may also be a factor. Therefore delivery time is not simply derived from computing power and task size, but may be related to them. This dependency may be exploited at the requestor node or at the computing node to minimize the number of attributes exposed.

The following provides some example attributes that may be included in a UCCP. These attributes are only examples and none of the attributes described below are required to be included in the UCCP, e.g., all the example attributes described below may be optional by default. In addition, other attributes that are not described in the below examples may also be included in a UCCP. However, some attributes in a UCCP may be defined as mandatory, e.g., based on an identified UCCI.

A first example UCCP attribute may be task size. The task size may be defined in Megabytes (MB) and may include a range of MB values. The input may be the required Random Access Memory (RAM) by the requestor node or the offered RAM by the computing node and an output data size, e.g., volume of information to be offload and expected to be returned. As described above, this example UCCP attribute may also impact the delivery time.

A second example UCCP attribute may be task complexity. The task complexity may be defined in instructions per byte of code (or similar) based on the complexity of the computation to be performed, or that can be handled. This example attribute may represent a value indicating the computational or algorithmic complexity associated with a computing task/request.

A third example UCCP attribute may be delivery time. The delivery time may be defined in units of time (e.g., UTC, Unix-time) or could be duration (e.g., given the value of the other attributes in the profile, how quickly a result may be returned (seconds)). The time at which the result is required may include a tolerance. This example UCCP attribute may be dependent upon available computing resources, task size, blocking, etc. This example UCCP attribute may impact communication data rates.

A fourth example UCCP attribute may be a lock or interruptability. The lock may be defined as a Boolean (e.g., true or false) or an enumerated attribute (e.g., identifying a specific locking mechanism, if any). This attribute identifies whether the computing request is interruptible by another call (or request) from the same application/client. The attribute may also identify a computing request associated with a portion of code that needs to run to completion without being interrupted (e.g., similar to a “critical section” in software). For example, a blocking task should not be preempted.

A fifth example UCCP attribute may be a blocking/synchronous call. The blocking/synchronous call may be defined as a Boolean. This example attribute may indicate whether the computing request may be executed in a synchronous or an asynchronous manner. For example, for a synchronous computing task, a next instruction of the program (after the call) may only be executed after the computing request has finished. Whereas, an asynchronous computing task invokes an operation and immediately returns from the call to continue execution at the next instruction, such that the result of the computing task may be delivered asynchronously at a later time.

A sixth example UCCP attribute may be computing power. The computing power may be defined in units of million instructions per second (MIPS), floating-point operations per second (FLOPS), etc.

A seventh example UCCP attribute may be reliability. The reliability may be expressed as a Mean Time Before Failure (MTBF).

An eighth example UCCP attribute may be availability. The availability may be expressed as a percentage of likely downtime.

A ninth example UCCP attribute may be privacy. The privacy may be expressed as an enumerated attribute that identifies a required isolation level, e.g., task level or core level isolation. This attribute may relate to trusted computing/execution environments.

A tenth example UCCP attribute may be security. The security may be expressed as an enumerated attribute that identifies communication link security requirements, e.g., required, offered integrity, ciphering capability on communication link between offloading and computing nodes. In other examples, the security may include that the request is to run in a trusted execution environment.

An eleventh example UCCP attribute may be priority and preemption. The priority and preemption may be expressed as enumerated attributes that indicate priority and/or preemption level. These attributes indicate may indicate a relative priority of the computing request in a manner similar to task priority within an operating system.

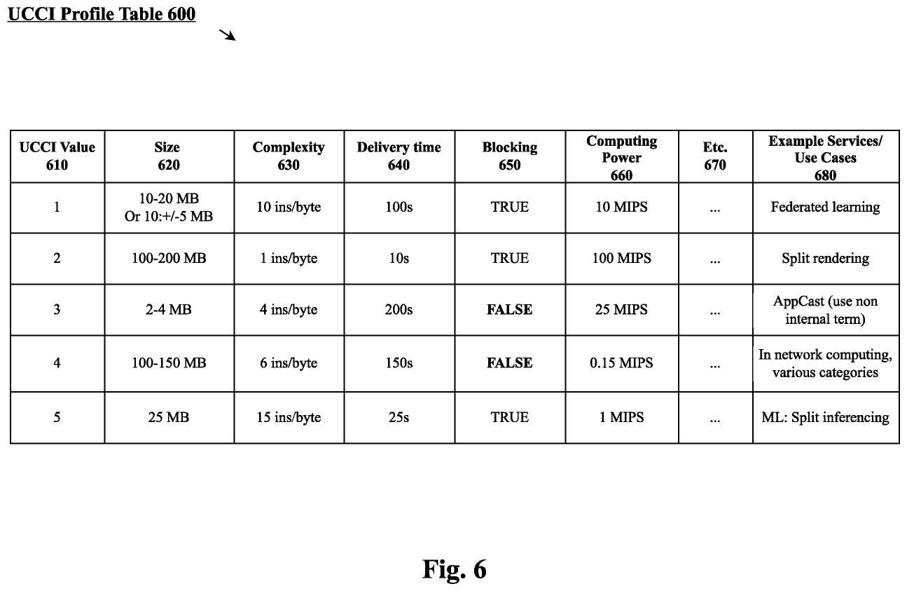

FIG. 6 shows an example UCCP table 600 according to various example embodiments. The UCCP table 600 is only an example including example UCCP attributes and example values for the UCCP attributes. As described above, an actual UCCP may include any number of attributes, some of which may be mandatory and some of which may be optional. In some example embodiments, all the attributes may be optional, e.g., none of the attributes are mandatory.

The UCCP table 600 includes eight (8) columns 610-680. The first column 610 is the UCCI index value for the corresponding row of the UCCP table 600, e.g., each of the indexes 1-5 corresponds to the values in the row for the attributes 620-680. The columns 620-660 show some of the example UCCP attributes that were described above including example values for these UCCP attributes. The column 670 shows that the table may include additional attributes. The column 680 shows a description of an example use case or service for which the corresponding UCCP may be used. However, as described above, just because the UCCP was defined for a particular use case or service, does not mean that the UCCP is limited to being used for that purpose.

In the following examples, a centralized approach to node matching (e.g., matching a requestor node with a computing node) where the DCMF is responsible for performing the matching operation is described. For instance, the DCMF may manage the node matching procedure and select a computing node for the node requesting computing resources. However, the example embodiments are not limited to a centralized approach for matching. In other example embodiments, a distributed approach where a DCA is responsible for performing the matching operation may be used. For instance, the requestor node may manage the matching procedure using information provided by the UCCP from the computing node. Thus, while the below example embodiments show the matching occurring at the DCMF, there is no requirement that the matching occur at the DCMF. Any other node may implement the matching procedure performed by the DCMF as described below.

FIG. 7 shows an example signaling diagram 700 for centralized node matching according to various example embodiments. The signaling diagram 700 includes a DCAc 701 of the UE 110, a DCAs 702 of the computing node 112, the DCMF 310, the NCRF 312 and an application function (AF) 703.

In 705, the AF 703 registers one or more computing nodes with the network. In this example, the NCRF 312 handles the registration for the network. However, in other examples, the AF 703 may register the one or more computing nodes with a network exposure function or any other appropriate type of network function.

During the registration procedure, the AF 703 may provide the network with the UCCPs of the computing nodes for which the AF 703 is responsible. For example, the AF 703 may provide the UCCPs supported by the computing node 112. As described above, this information may include the complete UCCP(s) supported by the computing node 112 or a UCCI that indicates the UCCP indexes which the computing node 112 supports. In this example, it is considered that the AF 703 provides the network with the UCCP information for the computing node 112. However, the AF 703 may also provide UCCP information for other nodes for which the AF 703 is responsible, including the UE 110 if that node also supports being a computing node.

In 710, the DCAs 702 of the computing node 112 registers with the DCMF 310. The DCAs 702 may be triggered to initiate the registration procedure based on any appropriate type of event or predetermined condition. To provide some examples, the DCAs 702 may trigger the registration request based on the computing node 112 being powered on or based on user input.

The registration procedure may comprise authenticating the DCAs 702 of the computing node 112 to operate in the network as a computing node for devices with a computing need. In addition, the registration procedure may also include providing the DCMF 310 with an indication of the UCCP(s) that the DCAs 702 supports.

In 712, during the registration procedure, the DCMF 310 may communicate with the NCRF 312 to obtain the credentials for authenticating the computing node 112. However, the DCMF 310 is not required to obtain these credentials during the registration procedure (if at all) and may obtain this type of information at any appropriate time and from any appropriate source.

In 715, the DCAc 701 of the UE 110 registers with the DCMF 310. The DCAc 701 may be triggered to initiate the registration procedure based on any appropriate type of event or predetermined condition. To provide some examples, the DCAc 701 may trigger the registration request based on the UE 110 being powered on, an application being launched at the UE 110 or based on user input.

The registration procedure may comprise authenticating the DCAc 701 of the UE 110 to operate in the network as a device to be served by a computing node. In addition, the registration procedure may also include providing the DCMF 310 with an indication of the UCCP(s) that the DCAc 701 supports.

In 717, during the registration procedure, the DCMF 310 may communicate with the NCRF 312 to obtain the credentials for authenticating the UE 110. However, the DCMF 310 is not required to obtain these credentials during the registration procedure (if at all) and may obtain this type of information at any appropriate time and from any appropriate source.

In 720, the DCAs 702 publishes computing resource availability information. For example, while the DCAs may support multiple UCCPs, because of current operations (e.g., loading, processing cores going offline, etc.) on the computing node 112 (e.g., native operations or offloaded operations), some or all of the supported UCCPs may not be available. The DCAs 702 may provide this information to the DCMF 310 so that when the DCMF 310 is performing the matching operation, the DCMF 310 only uses the available UCCPs for the computing node 112. Again, when the matching operation is performed at another node, the DCMF may publish this information so that the matching node is aware of the available UCCPs.

In 725, the DCAc 701 of the UE 110 may query the DCMF 310 for resource availability for offloading computing tasks. This query may be for a specific one or a set of UCCPs that may fulfill the application requirements for the offload of the computing tasks.

In 730, the DCMF 310 performs node matching in response to the query. For instance, the DCMF 310 may match the UCCP(s) included in the query 725 with suitable computing nodes that offer matching and available UCCP(s).

In 735, the DCMF 310 sends a message to the DCAc 701 of the UE 110 comprising the matching node information. This information may indicate to the UE 110 that there are available nodes for offloading computing tasks.

In 740, the UE 110 connects to the computing node 112 and offloads one or more computing tasks. The DCMF 310 may select a path to connect the UE 110 and the computing node 112 for offloading one or more computing tasks. In some embodiments, the DCMF 310 may work with an SMF of the network to find an adequate path for the UE 110 to the computing node 112. However, the DCMF 310 is not required to work with a SMF and may work with any appropriate number of network nodes to discover the path between the UE 110 and the computing node 112. The DCMF 310 may send information to the UE 110 to enable the UE 110 to connect to the computing node 112 for computing task offloading in the node matching information. In other embodiments, the network may provide this type of information using radio resource control (RRC) signaling, system information, NAS signaling or any other appropriate type of mechanism.

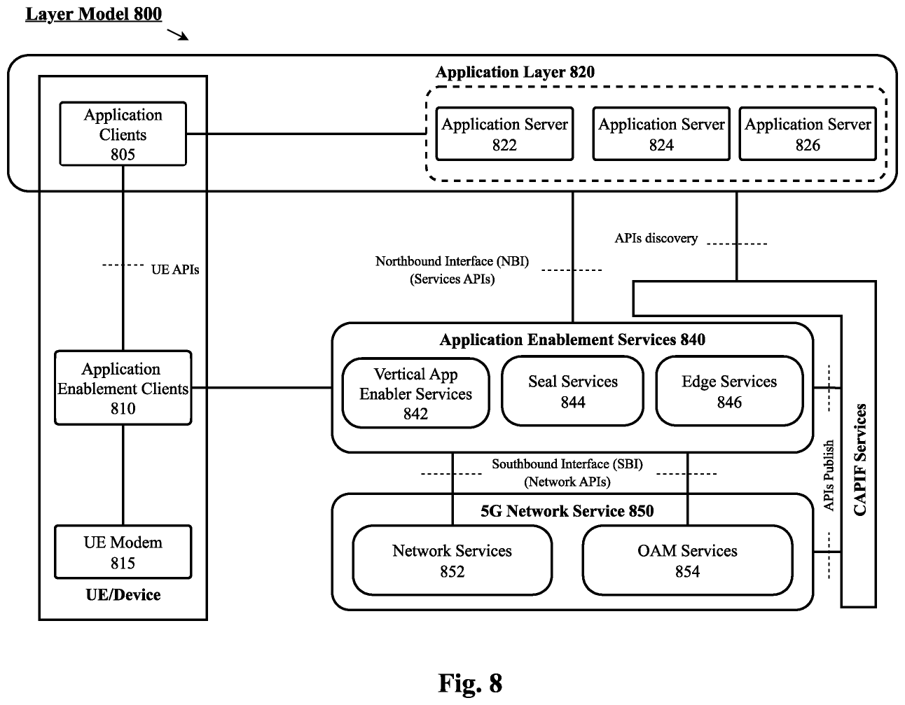

FIG. 8 shows a layer model 800 for abstracting the UCCP profile matching according to various example embodiments. The left side of the layer model 800 shows the UE side layers, e.g., when the UE is operating as a requestor node, and the right side of the layer model 800 shows network side layers. When discussing the network side layers, the example of FIG. 8 shows 5G examples. While the exact nature of 6G networks are still to be defined, it is envisioned that 6G networks will have similar or analogous network layers and services.

The lower portion of the network side of the layer model 800 shows the transport layer that includes 5G Network Services 850, for example, network services 852 and Operations, Administration and Maintenance (OAM) services 854. These services are part of System Architecture Group 2 that defines interfaces and network functions of the core network. This layer corresponds to the UE Modem layer 815 on the UE side.

On the network side, above the 5G Network Services 850 layer, there is an Application Enablement Services layer 840 that includes, for example, services such as Vertical Application Enablement Services 842, Service Enabler Architecture Layer (SEAL) Services 844 and Edge Services 846. These services are part of System Architecture Group 6 and sit between the 5G Network Services 850 and the application layer and provides services to the application layer to abstract the complexity of the 5G Network Services 850. The UE side provides a similar layer for Application Enablement Clients layer 815. As will be described in greater detail below, in some example embodiments, this middle level (e.g., Application Enablement Services layer 840 and/or Application Enablement Clients layer 815) may provide the UCCP as a service to the application layers.

Continuing with the layer model 800, there may be an application layer 820 including application servers 822-826 and a corresponding application client 815 on the UE side.

On the UE side, if it is considered that the DCA is positioned at the application layer, then the application enablement client 810 may provide services to an application client 805 (via the UE application programming interface (API)) and equivalently the various application enablement services 840 may provide services to the application servers 822-826 via the Northbound Interface (NBI)/Service APIs). Thus, the enabler layer (on both the network side and the UE side) may offer services to the application layer with regards to the UCCP and privacy preservation.

Again, to provide a counterexample to start, the application layer may be ignorant of the attributes used for any UCCP, e.g., which attributes are dependent on one another, which attributes are mandatory/optional, etc. Thus, if the application layer were to provide the attributes for the UCCP, the application layer may overexpose the attributes and that may lead to privacy and other issues.

On the other hand, in the example embodiments, the application enablement client 810 may provide a service related to the UCCP to the application client 805. For example, the application enablement client 810 may know the relationship between attributes in a particular UCCP and thus may minimize the amount of information exposed by the application layer through the UCCP. For example, if the application enablement client 810 detected a redundancy in the attributes provided by the application client 805, the application enablement client 810 may remove such a redundancy. To provide a specific example, the application enablement client 810 may know a Guaranteed Bit Rate (GBR) in bits per second (bps)*(task size)=one way delay. Thus, in this example it would not be necessary to include the required round trip time (excluding task execution time).

In another example, the application enablement client 810 may determine which attributes are mandatory and which attributes are optional for a particular UCCP. For example, the application enablement client 810 may know the application being executed by the application client 805 and based on this information may select mandatory or optional attributes for a UCCP.

In a still further example, the application enablement client 810 may mask any application client 805 specific identifiers, by, for example, providing an identifier of the application enablement client 810 in place of any identifiers of the application client 805. Thus, the matching node or any other node may be unaware of the application client 805 when receiving the UCCP for the offload task.

In an additional example, the application enablement client 810 may select the UCCP, e.g., directly mapping or learning the most appropriate UCCP using artificial intelligence (AI)/machine learning (ML), on behalf of the application client 805. For example, the application client 805 may would provide the raw requirements/capabilities for the offload computing task and the application enablement client 810 may select the appropriate corresponding UCCP(s). In the AI/ML example, the application enablement client 810 may initially pass more UCCP attributes for a particular offloaded computing task. However, the application enablement client 810 may learn over time which attributes are more critical and exclude those attributes that are not as critical or mark those attributes that are less critical as optional.

In the above examples it was described that the application enablement client 810 was providing the UCCP service to the application client 805. However, in a similar manner, the application enablement services 840 may also provide the same or similar UCCP services to the application servers 822-826.

### Examples

In a first example, a method comprising generating, for transmission to a network, a request for computing resource availability for a computing task to be offloaded from the apparatus, wherein the request comprises an indication of a Ubiquitous Computing Characteristics Profile (UCCP) comprising one or more attributes related to the computing task and processing, based on signals received from the network, computing node information associated with a network node, wherein the UE offloads the computing task to the network node.

In a second example, the method of the first example, wherein the one or more attributes comprise one of a task size of the computing task, a task complexity of the computing task, a delivery time of outputs for the computing task, an indication of whether the computing task is locked, an indication of whether the computing task is interruptible, an indication of whether the computing task is to be executed in a synchronous manner, an indication of whether the computing task is to be executed in an asynchronous manner, computing power required for the computing task, a reliability required for the computing task, an availability required for the computing task, a privacy level of the computing task, a security level of the computing task, or a priority of the computing task.

In a third example, the method of the first example, wherein the indication of the UCCP comprises a Ubiquitous Compute Characteristics Indicator (UCCI) index value identifying the UCCP.

In a fourth example, the method of the first example, wherein the UCCP was created for a first computing task and wherein the computing task is a second computing task that is different from the first computing task.

In a fifth example, the method of the first example, wherein the UCCP comprises a plurality of attributes.

In a sixth example, the method of the fifth example, wherein at least one attribute is indicated as mandatory for the computing task.

In a seventh example, the method of the fifth example, wherein at least one attribute is indicated as optional for the computing task.

In an eighth example, the method of the fifth example, further comprising excluding a first set of the plurality of attributes from the request.

In a ninth example, the method of the fifth example, wherein at least one of the plurality of attributes comprise a range of values or a tolerance for the at least one of the plurality of attributes.

In a tenth example, the method of the fifth example, wherein a first attribute has a dependency on a second attribute, the method further comprising determining whether the first attribute is to be included in the UCCP based on the dependency.

In an eleventh example, the method of the first example, further comprising selecting the UCCP based on input from a user of the apparatus.

In a twelfth example, the method of the first example, further comprising selecting the UCCP based on an application being executed by the apparatus.

In a thirteenth example, the method of the first example, wherein the processing circuitry executes an application layer and an application enablement layer.

In a fourteenth example, the method of the thirteenth example, wherein the application layer determines the one or more attributes comprises a plurality of attributes related to the computing task and wherein the application enablement layer determines that a first set of attributes of the plurality of attributes is to be excluded from the request.

In a fifteenth example, the method of the thirteenth example, wherein the application layer determines the one or more attributes comprises a plurality of attributes related to the computing task and wherein the application enablement layer determines that at least one of the attributes is a mandatory attribute and at least one of the attributes is an optional attribute.

In a sixteenth example, the method of the thirteenth example, wherein the application layer indicates an identification for the request and the application enablement layer substitutes an identification of the application enablement layer for the identification of the application layer in the request.

In a seventeenth example, the method of the thirteenth example, wherein the application layer determines the one or more attributes and the application enablement layer determines the UCCP corresponding to the one or more attributes.

In an eighteenth example, a processor configured to perform any of the first through seventeenth examples.

In a nineteenth example, a user equipment (UE) comprising a transceiver configured to communicate with a network and a processor communicatively coupled to the transceiver and configured to perform any of the first through seventeenth examples.

In a twentieth example, a method comprising generating, for transmission to a network, computing resource availability information comprising an indication of a Ubiquitous Computing Characteristics Profile (UCCP) comprising one or more attributes and establishing a user plane with a user equipment (UE), wherein the UE offloads one or more computing tasks to the apparatus based on the UCCP.

In a twenty first example, the method of the twentieth example, wherein the one or more attributes comprise one of a task size of the computing task, a task complexity of the computing task, a delivery time of outputs for the computing task, an indication of whether the computing task is locked, an indication of whether the computing task is interruptible, an indication of whether the computing task is to be executed in a synchronous manner, an indication of whether the computing task is to be executed in an asynchronous manner, computing power required for the computing task, a reliability required for the computing task, an availability required for the computing task, a privacy level of the computing task, a security level of the computing task, or a priority of the computing task.

In a twenty second example, the method of the twentieth example, wherein the indication of the UCCP comprises a Ubiquitous Compute Characteristics Indicator (UCCI) index value identifying the UCCP.

In a twenty third example, the method of the twentieth example, wherein the UCCP was created for a first computing task and wherein the computing task is a second computing task that is different from the first computing task.

In a twenty fourth example, the method of the twentieth example, wherein the UCCP comprises a plurality of attributes.

In a twenty fifth example, the method of the twenty fourth example, further comprising excluding a first set of the plurality of attributes from the computing resource availability information.

In a twenty sixth example, the method of the twenty fourth example, wherein at least one of the plurality of attributes comprise a range of values or a tolerance for the at least one of the plurality of attributes.

In a twenty seventh example, the method of the twenty fourth example, wherein a first attribute has a dependency on a second attribute, further comprising determining whether the first attribute is to be included in the UCCP based on the dependency.

In a twenty eighth example, the method of the twentieth example, wherein the UCCP comprises a plurality of UCCPs, further comprising generating, for transmission to the network, an indication of whether each of the UCCPs is currently available.

In a twenty ninth example, a processor configured to perform any of the twentieth through twenty eighth examples.

In a thirtieth example, a user equipment (UE) comprising a transceiver configured to communicate with a network and a processor communicatively coupled to the transceiver and configured to perform any of the twentieth through twenty eighth examples.

In a thirty first example, a device comprising a network interface configured to communicate with a network and a processor communicatively coupled to the network interface and configured to perform any of the twentieth through twenty eighth examples.

In a thirty second example, a method comprising processing, based on signals received from a first network node, computing resource availability information comprising an indication of a first Ubiquitous Computing Characteristics Profile (UCCP) comprising one or more attributes; processing, based on signals received from a second network node a request for computing resource availability for a computing task to be offloaded from the apparatus, wherein the request comprises an indication of a second UCCP comprising one or more attributes related to the computing task and determining whether the first UCCP satisfies the one or more attributes of the second UCCP.

In a thirty third example, the method of the thirty second example, further comprising generating, for transmission to the second network node, computing node information associated with the first network node, wherein the second network node offloads one or more computing tasks to the first network node.

In a thirty fourth example, the method of the thirty second example, further comprising processing, based on signals received from a third network node, computing resource availability information comprising an indication of a third UCCP comprising one or more attributes, determining whether the third UCCP satisfies the one or more attributes of the second UCCP and selecting the first network node or the third network node based on whether the first UCCP satisfies the one or more attributes of the second UCCP or the third UCCP satisfies the one or more attributes of the second UCCP.

In a thirty fifth example, the method of the thirty fourth example, wherein, when both the first UCCP and the third UCCP satisfy the one or more attributes of the second UCCP, further comprising selecting the first network node or the third network node based on comparing the one or more attributes of the first UCCP with the one or more attributes of the second UCCP and comparing the one or more attributes of the third UCCP with the one or more attributes of the second UCCP.

In a thirty sixth example, the method of the thirty second example, wherein the first UCCP comprises a plurality of UCCPs, further comprising processing, based on signals received from the first network node, an indication of a current availability of each of the plurality of UCCPs and generating, for publishing to subscribed network nodes, an indication of the current availability of each of the plurality of UCCPs.

In a thirty seventh example, a processor configured to perform any of the thirty second through thirty sixth examples.

In a thirty eighth example, a network function configured to perform any of the thirty second through thirty sixth examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as ios, Android, etc. The example embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources. The present disclosure contemplates that in some instances, this gathered data may include personal information data that uniquely identifies or can be used to identify a specific person. Such personal information data can include location data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, location data of other users (e.g., the application specific data) may be used to improve node matching between computing nodes and devices with computing needs.

The present disclosure contemplates that those entities responsible for the collection, analysis, disclosure, transfer, storage, or other use of such personal information data will comply with well-established privacy policies and/or privacy practices.

In particular, such entities would be expected to implement and consistently apply privacy practices that are generally recognized as meeting or exceeding industry or governmental requirements for maintaining the privacy of users. Such information regarding the use of personal data should be prominent and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, the DCMF may be configured such that it may not be aware of what the actual computing task to be performed comprises. Instead, the DCMF, the DCAs and the DCAc may handle computing tasks identified by a computing task ID provisioned by the application provider and/or application client. In another example, the communication path between the device with a computing need and a computing node may be managed by the mobile network. Thus, the device with the computing need may be unaware of the location of the computing node. In addition, a trust level may control which computing nodes may be matched to a device with a computing need.

It is the intent of the present disclosure that personal information data should be managed and handled in a way to minimize risks of unintentional or unauthorized access or use. In addition to the examples provided above, risk can be minimized by limiting the collection of data and deleting data once it is no longer needed. When applicable, data de-identification can be used to protect a user's privacy. De-identification may be facilitated, when appropriate, by removing identifiers, controlling the granularity or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, the example DCAc does not require a specific location of the candidate computing nodes and/or the location granularity may be limited to a high level.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. An apparatus comprising processing circuitry configured to:
generate, for transmission to a network, a request for computing resource availability for a computing task to be offloaded from the apparatus, wherein the request comprises an indication of a Ubiquitous Computing Characteristics Profile (UCCP) comprising one or more attributes related to the computing task; and
process, based on signals received from the network, computing node information associated with a network node, wherein the apparatus offloads the computing task to the network node.

2. The apparatus of claim 1, wherein the one or more attributes comprise one of a task size of the computing task, a task complexity of the computing task, a delivery time of outputs for the computing task, an indication of whether the computing task is locked, an indication of whether the computing task is interruptible, an indication of whether the computing task is to be executed in a synchronous manner, an indication of whether the computing task is to be executed in an asynchronous manner, computing power required for the computing task, a reliability required for the computing task, an availability required for the computing task, a privacy level of the computing task, a security level of the computing task, or a priority of the computing task.

3. The apparatus of claim 1, wherein the indication of the UCCP comprises a Ubiquitous Compute Characteristics Indicator (UCCI) index value identifying the UCCP.

4. The apparatus of claim 1, wherein the UCCP was created for a first computing task and wherein the computing task is a second computing task that is different from the first computing task.

5. The apparatus of claim 1, wherein the UCCP comprises a plurality of attributes.

6. The apparatus of claim 5, wherein at least one attribute is indicated as mandatory for the computing task.

7. The apparatus of claim 5, wherein at least one attribute is indicated as optional for the computing task.

8. The apparatus of claim 5, wherein the processing circuitry is further configured to:
exclude a first set of the plurality of attributes from the request.

9. The apparatus of claim 5, wherein at least one of the plurality of attributes comprise a range of values or a tolerance for the at least one of the plurality of attributes.

10. The apparatus of claim 5, wherein a first attribute has a dependency on a second attribute, wherein the processing circuitry is further configured to:
determine whether the first attribute is to be included in the UCCP based on the dependency.

11. The apparatus of claim 1, wherein the processing circuitry is further configured to:
select the UCCP based on input from a user of the apparatus.

12. The apparatus of claim 1, wherein the processing circuitry is further configured to:
select the UCCP based on an application being executed by the apparatus.

13. The apparatus of claim 1, wherein the processing circuitry executes an application layer and an application enablement layer.

14. The apparatus of claim 13, wherein the application layer determines the one or more attributes comprises a plurality of attributes related to the computing task and wherein the application enablement layer determines that a first set of attributes of the plurality of attributes is to be excluded from the request.

15. The apparatus of claim 13, wherein the application layer determines the one or more attributes comprises a plurality of attributes related to the computing task and wherein the application enablement layer determines that at least one of the attributes is a mandatory attribute and at least one of the attributes is an optional attribute.

16. The apparatus of claim 13, wherein the application layer indicates an identification for the request and the application enablement layer substitutes an identification of the application enablement layer for the identification of the application layer in the request.

17. The apparatus of claim 13, wherein the application layer determines the one or more attributes and the application enablement layer determines the UCCP corresponding to the one or more attributes.

18. An apparatus comprising processing circuitry configured to:
generate, for transmission to a network, computing resource availability information comprising an indication of a Ubiquitous Computing Characteristics Profile (UCCP) comprising one or more attributes; and
establish a user plane with a user equipment (UE), wherein the UE offloads a computing task to the apparatus based on the UCCP.

19. One or more processors of a distributed computing management function (DCMF) configured to:
process, based on signals received from a first network node, computing resource availability information comprising an indication of a first Ubiquitous Computing Characteristics Profile (UCCP) comprising one or more attributes;
process, based on signals received from a second network node a request for computing resource availability for a computing task to be offloaded from the second network node, wherein the request comprises an indication of a second UCCP comprising one or more attributes related to the computing task; and
determine whether the first UCCP satisfies the one or more attributes of the second UCCP.

20. The one or more processors of claim 19, further configured to:
generate, for transmission to the second network node, computing node information associated with the first network node, wherein the second network node offloads one or more computing tasks to the first network node.
